(19) United States
(12) Patent Application Publication
(10) Pub. No.: US 2004/0117113 A1
(43) Pub. Date: Jun. 17, 2004

(54) Updating routing and traffic flow data and vehicle navigation device

(76) Inventors: Arne Friedrichs, Braunschweig (DE); Gerd Draeger, Braunschweig (DE); Michael Laedke, Hildesheim (DE); Volker Skwarek, Bad Salzdefurth (DE)

Correspondence Address: KENYON & KENYON, ONE BROADWAY, NEW YORK, NY, 10004, US

(21) Appl. No.: 10/467,447

(22) PCT Filed: Jan. 17, 2002
(86) PCT No.: PCT/DE02/00114

(30) Foreign Application Priority Data
Feb. 7, 2001 (DE) 101 05 449.1

(51) Int. Cl. G01C 21/30

(52) U.S. Cl. 701/210; 340/995.14

(57) ABSTRACT

The present invention relates to a method for updating route data stored in a vehicle navigation device, particularly an offboard vehicle navigation device, the route data being updated in response to the occurrence of at least one predetermined event.

According to the present invention, the method includes the following step: Transmitting route query data to at least one center when at least one predetermined, traffic-flow-induced event occurs.

The present invention also relates to a vehicle navigation device and a method for updating traffic-flow data.

The present invention relates to a method for updating route data stored in a vehicle navigation device, particularly an offboard vehicle navigation device, the route data being updated in response to the occurrence of at least one predetermined event. The present invention also relates to a vehicle navigation device, particularly an offboard vehicle navigation device, provided to receive and to store route data from a center. In addition, the present invention relates to a method for updating stored traffic-flow data suitable for calculating route data.

### BACKGROUND INFORMATION

Vehicle navigation devices are well-known. One type of vehicle navigation device carries along a complete database, based on which route data is calculated. For such vehicle navigation devices, methods exist for updating routes which are founded on two different basic ideas. According to the first basic idea, messages from external databases are used, for instance, TMC messages (TMC=traffic message channel), and their positions are compared to the planned route. If an event, e.g. a traffic jam, is reported for the planned route, then the vehicle navigation device determines an alternative route based on the database that is carried along. According to the second basic idea, provision is made for a manual input via a so-called “traffic jam ahead key” provided on the vehicle navigation device. When this key is pressed, the route section lying ahead for a specified route is considered to be very slow to use, and the vehicle navigation device calculates an alternative route based on the database carried along.

Moreover, so-called offboard vehicle navigation devices are known which do not carry along a complete database, based on which route data could be calculated. For these offboard vehicle navigation devices, to plan a route, at least the starting address and the destination address are transmitted to a center, which then sends back corresponding route data to the offboard vehicle navigation device. For vehicle navigation devices having an incorporated database, the problem may occur that the vehicle navigation device does not have complete traffic-flow data at its disposal for calculating alternative routes. Moreover, for the offboard vehicle navigation devices, the problem occurs that alternative routes cannot be calculated because of the lack of a database.

### SUMMARY OF THE INVENTION

Because the following step is provided in the method of the present invention:

a) transmitting route query data to at least one center when at least one predetermined event occurs induced by the traffic flow,

the calculation of updated route data in a center may be requested. In this manner, for offboard vehicle navigation devices, the condition is provided to receive updated route data, it being possible, regardless of whether it is a vehicle navigation device with incorporated database or an offboard vehicle navigation device, to make more extensive traffic-flow data available to such a center than to a vehicle navigation device.

The method according to the present invention preferably includes the following further steps:

b) calculating updated route data in the center, and

c) transmitting the updated route data to the vehicle navigation device,

it being possible to calculate the updated route data in the center on the basis of current and virtually complete traffic-flow data and digital road maps available there. Since far greater computing capacity can be provided in such a center than in a vehicle navigation device, it is possible to calculate the updated route data using more complex algorithms, so that qualitatively better results may be achieved.

Furthermore, in the method of the present invention for updating route data, the at least one predetermined traffic-flow-induced event preferably includes the occurrence of traffic-flow interruptions on the originally planned route. Such traffic-flow interruptions may include, for example, those caused by traffic jams or the weather.

In the method of the present invention for updating route data, provision may be made to supply traffic-flow data manually and/or automatically to the vehicle navigation device. Traffic-flow data may be supplied manually, for example, by actuating an input of the “traffic jam ahead key” already mentioned. In this connection, it may also be advantageous if, in addition to actuating the “traffic jam ahead key”, the driver estimates the length of the traffic jam and supplies this information to the vehicle navigation device, as well. In this context, as likewise for all other input cases, it is conceivable for the input to be carried out via a speech input instead of a keyboard input.

Particularly in connection with the automatic feeding of traffic-flow data to the vehicle navigation device, provision may be made in the method of the present invention for updating route data, to transmit the traffic-flow data to the vehicle navigation device by vehicle sensors and/or by one or more external sources for vehicle-flow data. Suitable vehicle sensors make it possible to analyze the instantaneous traffic condition in the vehicle, similarly as is provided, for example, for the so-called floating-car-data (FCD) algorithms. Radio transmitters which send out the TMC messages already mentioned are considered, for instance, as external sources for traffic-flow data.

The method of the present invention for updating route data also preferably provides that the vehicle navigation device evaluates the traffic-flow data supplied to it to determine whether traffic-flow interruptions exist which require updating the route data. In this context, the vehicle navigation device may first check, for example, whether it is a significant or a rather slight traffic influence in terms of the planned route. If only an insignificant traffic influence exists in terms of the planned route, which may be determined, for example, on the basis of the corresponding TMC message or the corresponding TMC event code, then preferably no route query data is transmitted to the center. In contrast, a significant traffic interruption preferably always leads to a transmission of route query data to a center. It is also preferably provided in the method of the present invention for updating route data that the route query data includes at least parts of the traffic-flow data supplied to the vehicle navigation device and/or information obtained from the traffic-flow data supplied to the vehicle navigation device. In this connection, it is possible, for example, to insert internally produced messages such as “traffic jam ahead” or FCD messages into the route query data. In this context, it may also be provided that, already upon the recognition of slight traffic interruptions which do not yet necessarily require updating of the route data, the vehicle navigation device transmits corresponding traffic-flow data to a Center, for example, traffic-flow data with the contents “heavy to slow-moving traffic on route section XY.”

Provision may also be made in the method of the present invention for updating route data, that after receiving route query data and prior to calculating the updated route data, the center subjects at least certain traffic-flow data contained in the route query data to a check test, especially a plausibility check. This check test may be carried out, for example, by comparing the traffic-flow data contained in the route query data to other traffic-flow data available in the center. For instance, this may be advantageous in cases when traffic-flow data available to the center is more up-to-date than that supplied to the vehicle navigation device.

In the method of the present invention for updating route data, the updated route data is preferably calculated with the aid of traffic-flow data available in the center. To be understood by available traffic-flow data in this connection is that the corresponding traffic-flow data does not necessarily have to be on data carriers present physically in the center, but that the traffic-flow data may also be supplied, or supplied exclusively, via WAN or LAN connections. In each case, it is possible to make far more extensive traffic-flow data available in the center than is possible for a vehicle navigation device located in the vehicle.

In this connection, it may furthermore be provided to calculate the updated route data with the aid of traffic-flow data contained in route query data. This traffic-flow data may be compiled from a multitude of route query data which was transmitted by a multitude of vehicle navigation devices, such traffic-flow data preferably being subjected to a plausibility check prior to its use. This prevents, for example, falsely updated route data from being transmitted to other vehicle navigation devices due to a mistakenly actuated “traffic jam ahead key.”

Furthermore, in the method of the present invention for updating route data, the updated route data is preferably calculated with the aid of digital road maps available in the center.

To permit the calculation of routes based on traffic-flow data which is as extensive and current as possible, provision is also preferably made in the method of the present invention for updating route data, to update traffic-flow data available in the center in light of traffic-flow data contained in route query data. The traffic-flow data contained in the route query data is preferably subjected to a plausibility check prior to its use in this case, as well. In this connection, it is conceivable, for example, that a plurality of centers maintain a single traffic database, which the plurality of centers access.

In the method of the present invention for updating route data, the route data and/or the updated route data is preferably transmitted via a mobile radio network. Such a mobile radio network may operate, for example, according to the GSM (Global System for Mobile Communications) or the UMTS (Universal Mobile Telecommunications Service) standard.

Any vehicle navigation device suitable for participating in the method of the present invention for updating route data comes into the scope of the appertaining claims.

The same holds true for any center suitable for participating in the method of the present invention for updating route data.

Because the vehicle navigation system according to the present invention has:

means which transmit route query data to at least one center at least in response to the occurrence of at least one predetermined event induced by traffic flow, and

means which receive and store updated route data from at least one center as response to the transmitted route query data,

updated route data may be used which is calculated on the basis of far more extensive, current traffic-flow data, that can be made available to a center, but not to a vehicle navigation device.

Provision is preferably also made for the vehicle navigation device of the present invention, that the at least one predetermined, traffic-flow-induced event includes the occurrence of traffic-flow interruptions on the originally planned route, as was already explained in connection with the method of the present invention for updating route data.

The vehicle navigation device of the present invention preferably has input devices, to which traffic-flow data is supplied manually and/or automatically. For example, traffic-flow data may be input manually by actuating a “traffic jam ahead key”, it being possible to input additional information, e.g. an estimated traffic-jam length, if desired.

Particularly in connection with the automatic feeding of traffic-flow data, provision is preferably made in the vehicle navigation device of the present invention that the traffic-flow data is supplied to the input devices by vehicle sensors and/or by one or more external sources for traffic-flow data. The floating-car-data (FCD) algorithms already mentioned again come into consideration in connection with vehicle sensors. For example, on the basis of data about the vehicle acceleration or deceleration, the instantaneous vehicle speed and/or the average speed, it is possible to infer the traffic conditions prevailing at the moment, using such FCD algorithms. Radio stations which send out TMC messages are again considered, for example, as external sources for traffic-flow data.

The vehicle navigation device of the present invention preferably has evaluation devices which evaluate the supplied traffic-flow data to determine whether traffic-flow interruptions exist necessitating an updating of the route data. Similarly as for the method of the present invention for updating route data, it may also be provided in this connection, that no route query data is transmitted to a center if only a slight traffic influence exists, while route query data is preferably always transmitted to a center when there is a significant traffic interruption.

The route query data transmitted by the vehicle navigation device of the present invention to at least one center preferably includes at least parts of the traffic-flow data supplied via the input devices and/or information obtained from them. This traffic-flow data transmitted to a center may be used not only for calculating the updated route data, but in addition, with the aid of such traffic-flow data contained in the route query data, it is possible to update traffic-flow databases which one or more centers access.

In this connection, the vehicle navigation device of the present invention may also have means which transmit traffic-flow data to at least one center. These means may be formed by the same means which transmit route query data to at least one Center in response to the occurrence of at least one predetermined, traffic-flow-induced event. However, particularly for updating traffic-flow databases which the centers access, it may be advantageous if traffic-flow data which requires no updating of the route data, e.g. traffic-flow data with the contents “heavy to slow-moving traffic on route section XY”, is also transmitted to the center.

The vehicle navigation device of the present invention preferably has communication devices and/or it cooperates with separate communication devices to transmit the route query data and/or to receive the updated route data.

In this connection, mobile radio communications devices come especially into consideration, which are able to operate, for instance, according to the GSM or the UMTS standard.

Because the method of the present invention for updating stored traffic-flow data includes the following steps:

d) receiving traffic-flow data, transmitted by vehicle navigation devices, in at least one center in which the traffic-flow data suitable for calculating route data is available, and

e) updating the traffic-flow data, suitable for calculating route data, with the aid of at least some of the traffic-flow data transmitted by the vehicle navigation devices,

it is possible to make available a traffic-flow database which contains extremely current traffic-flow data transmitted by a great number of vehicle navigation devices. Of course, the traffic-flow data may additionally be updated by taking into consideration traffic-flow data received from other external sources. In this case, for example, TMC messages come into consideration again, or any suitable information offered by appropriate service providers.

With respect to the method of the present invention for updating traffic-flow data, the traffic-flow data transmitted by the vehicle navigation devices preferably constitutes components of route query data as was already explained in connection with the method of the present invention for updating route data and the vehicle navigation device according to the present invention.

Any device for carrying out the method of the present invention for updating stored traffic-flow data comes into the scope of the appertaining claims.

### BRIEF DESCRIPTION OF THE CRAWINGS

The present invention is explained in detail below with reference to the accompanying drawing.

The Figures show:

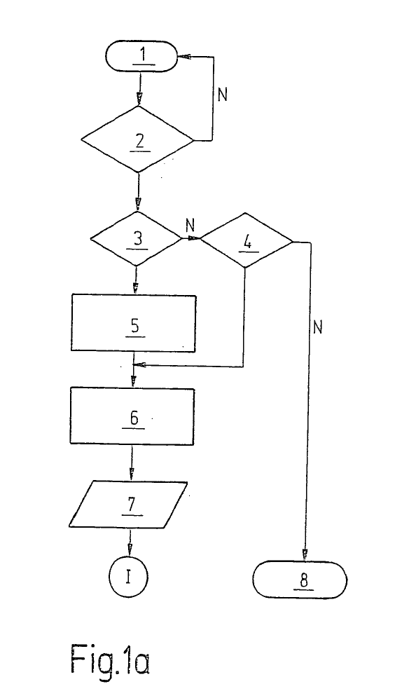

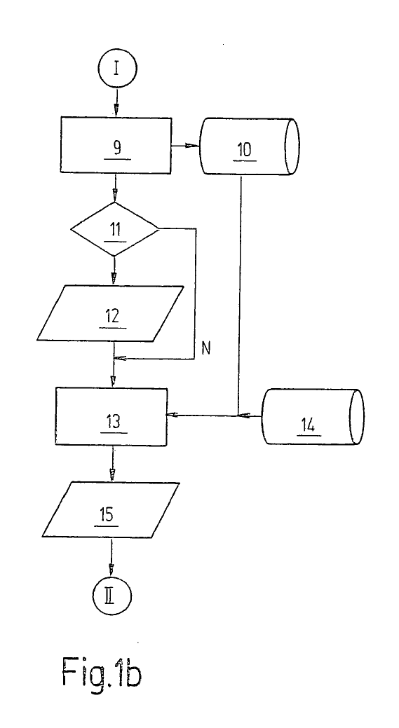

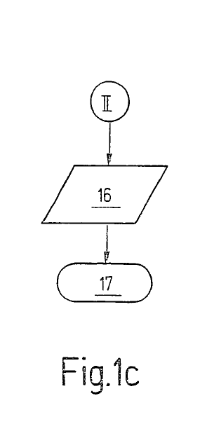

FIG. 1a a first section of a flow chart which illustrates an exemplary embodiment of the method of the present invention for updating route data and the method of the present invention for updating stored traffic-flow data, the first section of the flow chart being carried out in the vehicle, i.e., in the vehicle navigation device;

FIG. 1b a second section of the flow chart following the first section according to FIG. 1a, the second section of the flow chart being carried out in a center; and

FIG. 1c a third section of the flow chart following the second section according to FIG. 1b, the third section of the flow chart being carried out in the vehicle, i.e., in the vehicle navigation device.

The section of the flow chart shown in FIG. 1b follows the section of the flow chart shown in FIG. 1a via connection point I, while the section of the flow chart shown in FIG. 1c follows the section of the flow chart shown in FIG. 1b via connection point II. Blocks 1 through 17 shown in FIGS. 1a through 1c are assigned the functions from the following table:

Block Function

1 Beginning of the route guidance

2 Has a predetermined, traffic-flow-induced event occurred in the form of a traffic-flow interruption?

3 Was the traffic-flow interruption recognized on the basis of traffic-flow data generated in the vehicle?

4 Is the traffic-flow interruption significant for the originally planned route?

5 Supplement the route query data to be transmitted to the center with traffic-flow data generated in the vehicle

6 Supplement route query data with closed route sections

7 Transmit route query data to center

8 Begin route guidance

9 Update traffic-flow database in center

10 Traffic-flow database

11 Traffic-flow data generated in the vehicle included in the route query data?

12 Forwarding to traffic-data center for plausibility check

13 Calculating an alternate route

14 Digital map

15 Transmitting the updated route data to the vehicle

16 Updated route data in the vehicle navigation device

17 Vehicle guidance using updated route

The route guidance begins in block 1. In block 2, it is checked whether a predetermined, traffic-flow-induced event has occurred in the form of a traffic-flow interruption. If this is not the case, there is a return to block 1. If a predetermined, traffic-flow-induced event has occurred in the form of a traffic-flow interruption, there is a branching to block 3, in which it is checked whether the traffic-flow interruption was recognized on the basis of traffic-flow data generated in the vehicle. If this is the case, then the route query data is supplemented by the traffic-flow data generated in the vehicle. Otherwise, there is a branching to block 4, in which it is checked whether the traffic-flow interruption is significant for the originally planned route. If it is determined in block 4 that the traffic interruption is insignificant for the originally planned route, then there is a branching to block 8 in which the route guidance is continued on the basis of the original route data. After the route data to be transmitted to the Center has been supplemented by the traffic-flow data generated in the vehicle, or if it was determined that the traffic interruption is significant for the originally planned route, there is a branching to block 6. In block 6, the route query data is supplemented by closed route sections. In block 7, route query data is subsequently transmitted to at least one center, the route query data also including the original route data.

FIG. 1b, which follows FIG. 1a at connection point I, shows the section of the method according to the present invention proceeding in a center. In block 9, traffic-flow data stored in a traffic-flow database 10 is first updated. In block 11, it is checked whether the route data includes traffic-flow data generated in the vehicle. If this is the case, then there is a branching to block 12, in which the traffic-flow data generated in the vehicle is subjected to a plausibility check. Subsequently, or if it is determined in block 11 that the route query data includes no traffic-flow data generated in the vehicle, there is a branching to block 13 in which an alternate route is calculated. The alternate route is calculated on the basis of plausible traffic-flow data generated in the vehicle, traffic-flow data from traffic-flow database 10, and digital road maps 14. Subsequently, there is a branching to block 15, in which the updated route data is transmitted to the vehicle navigation device.

FIG. 1c illustrates the condition in the vehicle after the reception of the updated route data. In block 16, the vehicle navigation device has at its disposal the updated route data which indicates a route that is optimized with respect to the current traffic situation. In block 17, the route guidance begins on the basis of the updated route data.

In the following, three examples for the practical execution of the method according to the present invention are described in greater detail.

### EXAMPLE 1

A vehicle is equipped with an offboard vehicle navigation device and calculates a route for the distance between Hamburg and Munich, in which the up-to-date traffic messages through the center are implemented. Near Kassel, this vehicle gets into a traffic jam caused by an accident which was not yet known at the moment the route was calculated. Because of this, the driver actuates the “traffic jam ahead key” on the vehicle navigation device. Since the end of the traffic jam is not in visual range, the driver estimates the length of the traffic jam at “greater than 2 km.” The vehicle navigation device thereupon sends a message in the form of route query data to the center. In addition to the route query for the distance between the present point and a destination point, this route query data also includes the traffic-jam message, the current road and the estimated route section which, on the basis of the traffic-jam message, must be taken into account in the next route calculation. Additionally, the center is connected to a traffic-data provider to which it sends the message that a vehicle has reported a traffic jam on the specified road section. The center now calculates an alternative route on which the vehicle is able to drive around the traffic jam, and transmits the alternative route in the form of updated route data to the vehicle.

### EXAMPLE 2

In the same scenario as for example 1, the traffic jam near Kassel is reported on the radio and is available for the navigation through a corresponding TMC message. The vehicle navigation device checks the traffic-flow data received through the TMC message and comes to the conclusion that it is a traffic interruption which is significant for the originally planned route. An inquiry, in the form of route query data, for an alternate route is thereupon transmitted to the center. The route query data also includes the received TMC message. Because the TMC message is an authenticated message, the current traffic-jam database in the center is adjusted using the up-to-date message. The center now calculates an alternative route for the vehicle and transmits it in the form of updated route data.

### EXAMPLE 3

In this case, the vehicle has an FCD-capable system component in which intelligent algorithms analyze the driving profile. Based on the driving profile, the FCD algorithm determines that the vehicle is in stop-and-go traffic and requests a new route from the center by transmitting route query data. The route query data includes additional information about the recognized traffic condition in the form of corresponding traffic-flow data, so that the center is able to calculate a better alternative. The traffic-flow data transmitted by the vehicle, i.e. by the vehicle navigation device, is checked in the center for plausibility and is optionally stored in a traffic-flow database, so that these messages may be taken into account in response to route queries from other road users.

The preceding description of the exemplary embodiments according to the present invention is used only for purposes of illustration and not for the purpose of limiting the present invention. Various changes and modifications are possible within the framework of the present invention, without departing from the scope of the invention or its equivalents.

What is claimed is:

1. A method for updating route data stored in a vehicle navigation device, particularly an offboard vehicle navigation device, the route data being updated in response to the occurrence of at least one predetermined event, wherein the method includes the following step:
a) transmitting route query data to at least one center when at least one predetermined traffic-flow-induced event occurs.

2. The method as recited in claim 1, wherein it also includes the following steps:
b) calculating updated route data in the center, and
c) transmitting the updated route data to the vehicle navigation device.

3. The method as recited in one of the preceding claims, wherein the at least one predetermined traffic-flow-induced event includes the occurrence of traffic-flow interruptions on the originally planned route.

4. The method as recited in one of the preceding claims, wherein traffic-flow data is supplied manually and/or automatically to the vehicle navigation device.

5. The method as recited in one of the preceding claims, wherein the traffic-flow data is transmitted to the vehicle navigation device by vehicle sensors and/or by one or more external sources for traffic-flow data.

6. The method as recited in one of the preceding claims, wherein the vehicle navigation device evaluates the traffic-flow data supplied to it to determine whether traffic-flow interruptions exist which necessitate an update of the route data.

7. The method as recited in one of the preceding claims, wherein the route query data includes at least parts of the traffic-flow data supplied to the vehicle navigation device and/or information obtained from the traffic-flow data supplied to the vehicle navigation device.

8. The method as recited in one of the preceding claims, wherein after receiving route query data and prior to calculating the updated route data, the center subjects at least certain traffic-flow data contained in the route query data to a check, particularly a plausibility check.

9. The method as recited in one of the preceding claims, wherein the updated route data is calculated with the aid of traffic-flow data available in the center.

10. The method as recited in one of the preceding claims, wherein the updated route data is calculated with the aid of traffic-flow data contained in route query data.

11. The method as recited in one of the preceding claims, wherein the updated route data is calculated with the aid of digital road maps available in the center.

12. The method as recited in one of the preceding claims, wherein traffic-flow data available in the center is updated on the basis of traffic-flow data contained in route query data.

13. The method as recited in one of the preceding claims, wherein the route query data and/or the updated route data is transmitted via a mobile telephony network.

14. A vehicle navigation device that is designed for participation in the method as recited in one of the preceding claims.

15. A center which is designed for participation in the method as recited in one of claims 1 through 13.

16. A vehicle navigation device, particularly an offboard vehicle navigation device, which is provided to receive and to store route data from a center, wherein it has the following devices:
means which transmit route query data to at least one center at least in response to the occurrence of at least one predetermined event induced by traffic flow, and
means which receive and store updated route data from at least one center as response to the transmitted route query data.

17. The vehicle navigation device as recited in claim 16, wherein the at least one predetermined traffic-flow-induced event includes the occurrence of traffic-flow interruptions on the originally planned route.

18. The vehicle navigation device as recited in one of claims 16 through 17, wherein it has input devices to which traffic-flow data is supplied manually and/or automatically.

19. The vehicle navigation device as recited in one of claims 16 through 18, wherein the traffic-flow data is supplied to the input devices by vehicle sensors and/or by one or more external sources for traffic-flow data.

20. The vehicle navigation device as recited in one of claims 16 through 19, wherein it has evaluation devices which evaluates the supplied traffic-flow data to determine whether traffic-flow interruptions exist which necessitate an update of the route data.

21. The vehicle navigation device as recited in one of claims 16 through 20, wherein the route query data includes at least parts of the traffic-flow data, supplied via the input devices, and/or information obtained from them.

22. The vehicle navigation device as recited in one of claims 16 through 21, wherein it also has:
means which transmit the traffic-flow data to at least one center.

23. The vehicle navigation device as recited in one of claims 16 through 22, wherein it has communication devices and/or cooperates with separate communication devices to transmit the route query data and/or to receive the updated route data.

24. The vehicle navigation device as recited in one of claims 16 through 23, wherein the communication devices are formed by mobile radio communications devices.

25. A method, particularly as recited in one of claims 1 through 13, for updating stored traffic-flow data suitable for calculating route data, wherein the method includes the following steps:
d) receiving traffic-flow data, transmitted by vehicle navigation devices, in at least one center in which the traffic-flow data suitable for calculating route data is available, and
e) updating the traffic-flow data, suitable for calculating route data, with the aid of at least some of the traffic-flow data transmitted by the vehicle navigation devices.

26. The method as recited in claim 25, wherein the traffic-flow data transmitted by the vehicle navigation devices is a component of route query data.

27. A device, particularly a vehicle navigation device as recited in one of claims 16 through 24, for carrying out the method as recited in one of claim 25 or 26.
